(19) United States
(12) Patent Application Publication
(10) Pub. No.: US 2026/0024095 A1
(43) Pub. Date: Jan. 22, 2026

(54) RESOLUTION GUIDANCE SYSTEM AND METHOD

(71) Applicant: Verint Americas Inc., Alpharetta, GA (US)

(72) Inventors: Karni GILON, Herzliya (IL); Shmuel LONDNER, Tel Aviv (IL)

(21) Appl. No.: 18/776,128

(22) Filed: Jul. 17, 2024

(51) Int. Cl. G06Q 30/015; G06F 40/35; G06F 40/40

(52) U.S. Cl. CPC G06Q 30/015; G06F 40/35; G06F 40/40

(57) ABSTRACT

Certain aspects of the disclosure provide methods and systems for providing resolution guidance to a help center agent are provided. One method generates a set of intent-resolution pairs based on a historical interactions, including: grouping similar intents extracted from the corpus of historical interactions in a same intent topic group of a plurality of intent topic groups, and grouping resolutions associated with the similar intents in a same resolution topic group of a plurality of resolution topic groups. Additionally, the method determines an intent of the current user utterance as a user intent. The method maps the user intent to one or more intent-resolution pairs from the set of intent-resolution pairs. Moreover, method provides, to the help center agent, one or more suggested resolutions corresponding to the one or more intent-resolution pairs. Also, the method provides, to the customer, a selected resolution from among the one or more suggested resolutions.

### BACKGROUND

### Field

Aspects of the present disclosure relate to contact center issue resolution, and more particularly to a resolution guidance system and method.

### Description of Related Art

The goal of a help center is to effectively address the needs and concerns of users by providing accurate information and resolving issues. For example, help centers often are provided by business entities to assist a customer with product-related technical support. In other circumstances, a help center may be provided by a government agency, such as, the Internal Revenue Service, to answer tax-related questions. Help centers are typically available to customers via telephone helpline or a chat module implemented on a website, for example.

A telephone call or chat sent to a help center may be received by a human, also known as a help center agent (or agent). Initially, the help center agent elicits details from the customer regarding the customer's identity and the nature of the call. Once the agent understands the need/concern they should offer the most appropriate steps towards a solution. However, many alternative actions may be reasonable. Some may be unhelpful, and some may lead to a resolution, but take more time than necessary.

For example, if the customer called due to an internet connectivity issue, the agent may suggest disconnecting and reconnecting the Wi-Fi, resetting the router, checking electricity supply, etc., in any order. There are several methods the agents can choose from, mostly involving intuition, guidelines, or experience. These methods may often lead to the wrong choice, resulting in a sub-optimal customer experience.

Providing an optimal course of action in the shortest amount of time, requires significant experience and training for the help center agent. Not only does the help center agent need to be familiar with relevant manuals (e.g., shop manuals, repair manuals, manual of regulations, etc.), but the help center agent should also be familiar with the most likely causes of the customer's issue, so that the help center agent can avoid suggesting actions that are least likely to address the issue.

Training and guiding the help center agent to select the best action to take for a certain customer intent is currently addressed in the following ways: written internal guidelines the help center agents need to follow, coaching by an experienced agent, and automatic agent assistance based on keyword or basic similarity search. However, each of these techniques have flaws.

A solution fully based on written internal guidelines the agents need to follow may result in inexperienced agents needing to search through the guidelines during the interaction, which may take time and annoy the customer. Additionally, the guidelines are not always updated according to application or technology changes, which may lead to errors even among experienced agents. Moreover, the customer may have already tried some of the options mentioned in the guidelines, further complicating the agent's choice.

Relying on coaching by an experienced agent can be expensive and inefficient. The experienced agent cannot be entirely dedicated to coaching, while the new agent may not be able to respond to calls unsupervised. Thus, neither employee is operating at full potential.

Current automatic agent assistance systems use keyword or basic similarity searches. The automatic agent assistance can capture local events, such as the agent not greeting a customer. However, the automatic agent assistance does not consider the larger context or automatically learn from past interactions, and is therefore not optimal for offering the best action.

### SUMMARY

Certain aspects provide a method for providing resolution guidance to a help center agent. The method may include generating a set of intent-resolution pairs based on a corpus of historical interactions, including: grouping similar intents extracted from the corpus of historical interactions in a same intent topic group of a plurality of intent topic groups, and grouping resolutions associated with the similar intents in a same resolution topic group of a plurality of resolution topic groups. The method may also include determining, by an intent engine, an intent of the current user utterance as a user intent. The method may furthermore include mapping the user intent to one or more intent-resolution pairs from the set of intent-resolution pairs. The method may in addition include providing, to the help center agent, one or more suggested resolutions corresponding to the one or more intent-resolution pairs. The method may moreover include providing, to the customer, a selected resolution from among the one or more suggested resolutions, the selected resolution being selected by the help center agent.

In certain other aspects, a method for providing resolution guidance to a help center agent may include providing a current user utterance from a customer to an intent engine. The method may also include determining, by the intent engine, an intent of the current user utterance as a user intent. The intent engine may employ artificial intelligence, such as a large language model (LLM), trained to determine the intent of the current user utterance. Certain aspects of the present disclosure may also reference past user utterances made during the present customer interaction with the help center agent. By including past utterances as well as the current user utterance, and even previous help center agent responses, a more comprehensive and accurate intent may be determined, thus leading to a more efficient and satisfactory resolution. The method may furthermore include prompting a generative artificial intelligence (GenAI) model to generate at least one action leading to a resolution of the current user utterance with a prompt including: the current user utterance, and domain-specific documentation. The method may in addition include providing, to the customer, a resolution selected by the help center agent from among the at least one action.

In certain other aspects, a processing system for providing resolution guidance to a help center agent may include a historical interactions datastore having a corpus of historical interactions stored therein. The processing system may also include a knowledge datastore having a corpus of domain-specific documentation stored therein. The processing system may furthermore include a memory having computer-executable instructions. The processing system may in addition include one or more processors configured to execute the computer-executable instructions and cause the processing system to: provide a current user utterance from a customer to an intent engine; determine, by the intent engine (which may employ artificial intelligence, such as a large language model (LLM), trained to determine the intent of the current user utterance), an intent of the current user utterance as an user intent; compare the user intent to a set of stored intent embeddings to identify one or more stored intent embeddings that are similar to the user intent; prompt a generative artificial intelligence (GenAI) model to generate at least one action leading to a resolution of the current user utterance with a prompt including: the current user utterance, historical interactions related to the one or more stored intent embeddings selected from the corpus of historical interactions, and documentation associated with the one or more stored intent embeddings selected from the corpus of domain-specific documentation; and providing, to the customer, a resolution selected by the help center agent from among the at least one action.

Other aspects provide processing systems configured to perform the aforementioned methods as well as those described herein; non-transitory, computer-readable media comprising instructions that, when executed by a processors of a processing system, cause the processing system to perform the aforementioned methods as well as those described herein; a computer program product embodied on a computer readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 depicts a block representation of an example resolution guidance system in accordance with certain aspects of the present disclosure.

FIG. 2 depicts a block diagram of intent discovery process for determining an intent of an utterance in accordance with certain aspects of the present disclosure.

FIG. 3 depicts an example content input to, generated by, and output from the intent discovery process shown in FIG. 2, in accordance with certain aspects of the present disclosure.

FIG. 4 depicts a block diagram of an issue resolution indication process for an interaction in accordance with certain aspects of the present disclosure.

FIG. 5 depicts an example content input to, generated by, and output from the issue resolution indication process shown in FIG. 4, in accordance with certain aspects of the present disclosure.

FIG. 6 depicts a block representation of example intent-resolution pairs with ubiquity weightings in accordance with certain aspects of the present disclosure.

FIG. 7 depicts a block representation of another example resolution guidance system in accordance with certain aspects of the present disclosure.

FIG. 8 depicts a representation of a data flow of an example resolution guidance system in accordance with certain aspects of the present disclosure.

FIG. 9 depicts an example method for providing resolution response suggestions to an agent in accordance with certain aspects of the present disclosure.

FIG. 10 depicts another example method for providing resolution response suggestions to an agent in accordance with certain aspects of the present disclosure.

FIG. 11 depicts an example processing system with which aspects of the present disclosure can be performed.

It is contemplated that elements and features of one embodiment may be beneficially incorporated in other embodiments without further recitation.

### DETAILED DESCRIPTION

Aspects of the present disclosure provide resolution guidance to a help center agent. A help center may be arranged as outward facing, providing assistance to customers, or inward facing, providing assistance to members of an institution, such as a company, university or government agency. Moreover, a help center agent may be a human trained to provide technical assistance and support for users of goods and services provided by or used in the institution. Alternatively, the help center agent may be a human resources agent tasked with providing support for human resource related issues. It is noted that while “help center agent” herein is used to identify a human being employed to provide assistance to individuals, aspects of the present disclosure may be applied to automated or AI systems configured in the role of a help center agent to provide assistance to individuals, without deviating from the scope and intent of the present disclosure.

Additionally, the term “customer” as applied herein is intended to encompass any individual using the help center services, such a user may be a purchaser of a good or service offered by a company, an employee of the institution, and the like. Thus, any user of the services provided by the help center may be considered a customer of the help center.

Aspects of the present disclosure provide systems and methods that present a help center agent with one or more suggested actions, or resolutions, in response to an utterance by a customer.

For example systems and methods, in accordance with aspects of the present disclosure, may receive a user utterance and identify a purpose, or intent, of the customer. Based on the identified intent, one or more resolutions may be identified among a set of intent-resolution pairs extracted from a corpus of historical interactions with past customers. Resolutions exceeding a prevalence (e.g., ubiquity) threshold may be presented to the help center agent as suggested resolutions from which the help center agent can choose. The chosen resolution is transmitted to the customer. In this way, aspects of the present disclosure provide a help center agent with guidance for addressing a customer's problem or intent for contact the help center. By providing suggested resolutions to the help center agent, aspects of the present disclosure reduce the time and effort needed to train a help center agent, while providing the customer with a high quality of service. For example, by using the most prevalent suggested resolution, the help center agent may respond to the user utterance in a manner that avoids or reduces the chance of proceeding on a sequence of actions that may not lead to an adequate final resolution to the customer's intent in an optimal sequence, or at all. Certain aspects of the present disclosure may arrange the suggested resolutions in descending order according to a ubiquity value assigned to each resolution. Thus, further simplifying selection of an appropriate resolution by the help center agent.

Resolutions may include reminders for the help center agent to ask the customer's name, particular model or serial number of the product with which the customer has an issue, the nature of the issue, what actions the customer performed prior to reaching out to the help center, and the like. During an initial interaction between the customer and the help center agent, resolutions asking for customer name or additional information about the issue may be most prevalent as such questions may apply to a large number of intents, regardless of the issue. As the interaction between the customer and the help center agent proceeds, the suggested resolutions may be more tailored to the actual intent of the call. A mature interaction between the customer and the help center agent may result in a small number of suggested resolutions, and perhaps only one suggested resolution. A benefit provided by aspects of the present disclosure over prior art scripted guidance manuals and the like, is that aspects of the present disclosure may access the most recent documentation and provide the resolution suggestions that have successfully addressed similar issues most recently, since the historical interactions may be periodically updated to reflect recent calls into the help center. Scripted guidance manuals, and training often lag behind the most current products being offered and issues being encountered. Consequently, under the prior art systems, even a well trained and experienced help center agent can become inefficient at resolving customer issues rather quickly, unless the help center agent receives periodic refresher training, for example.

### Example Resolution Guidance System

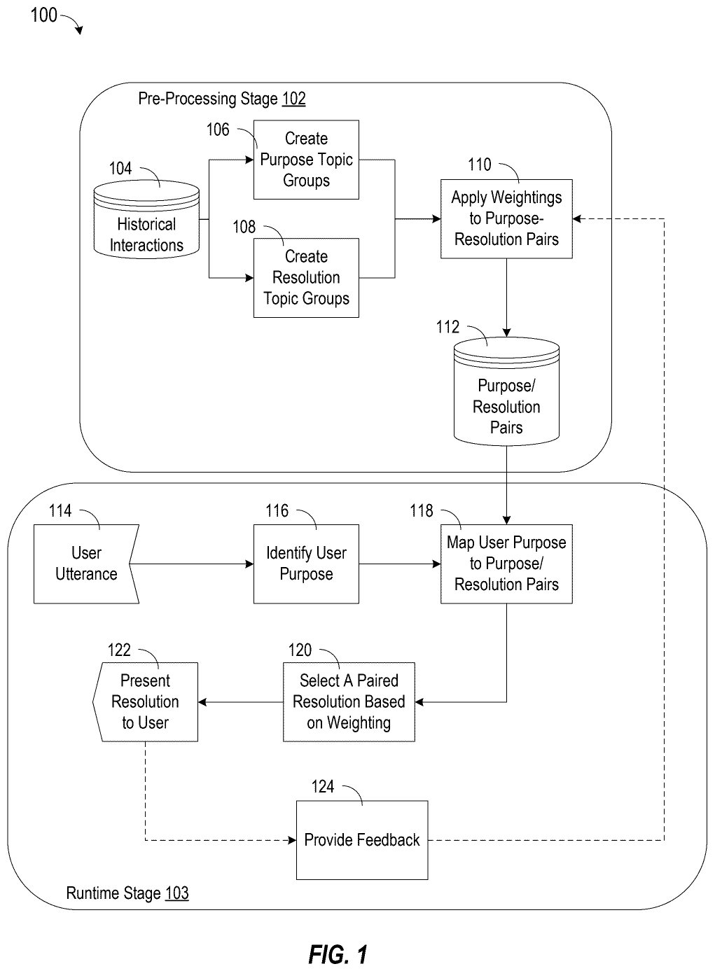

FIG. 1 depicts an example resolution guidance system 100 in accordance with certain aspects of the present disclosure. The resolution guidance system 100 may be a cloud-based distributed processing system in which components of the system may not be co-located in the same datacenter. Alternatively, resolution guidance system 100 may be configured as a local data server.

The resolution guidance system 100 includes a pre-processing stage 102 and a runtime stage 103. Prior to live operation of the resolution guidance system 100, the pre-processing stage 102 is executed. During the pre-processing stage 102, the resolution guidance system 100 is provided a corpus of historical interactions 104. The corpus of historical interactions 104 may include partial or complete transcripts of communications between customers and one or more help center agents, which may be human agents, artificial intelligence agents, expert systems, bots, and the like. The transcripts may include customer utterances stating an issue, problem or question that the customer needs resolved by the help center agent. An example issue needing a resolution may involve an Internet connectivity issue being experienced. An alternative example may involve an interpretation of a regulation, such as allowable tax exemptions. The corpus of historical interactions 104 may include thousands or tens of thousands of separate interactions. The size of the corpus of historical interactions 104 is limited by available storage resources for containing the data. More historical interactions may provide better resolution choices to the help center agent at the cost of a larger data storage requirement. Moreover, in order to maintain relevance of the resolution choices, new, recent interactions may be periodically added to the corpus of historical interactions 104. The pre-processing stage 102 may be executed each time new interactions are added to the corpus of historical interactions 104.

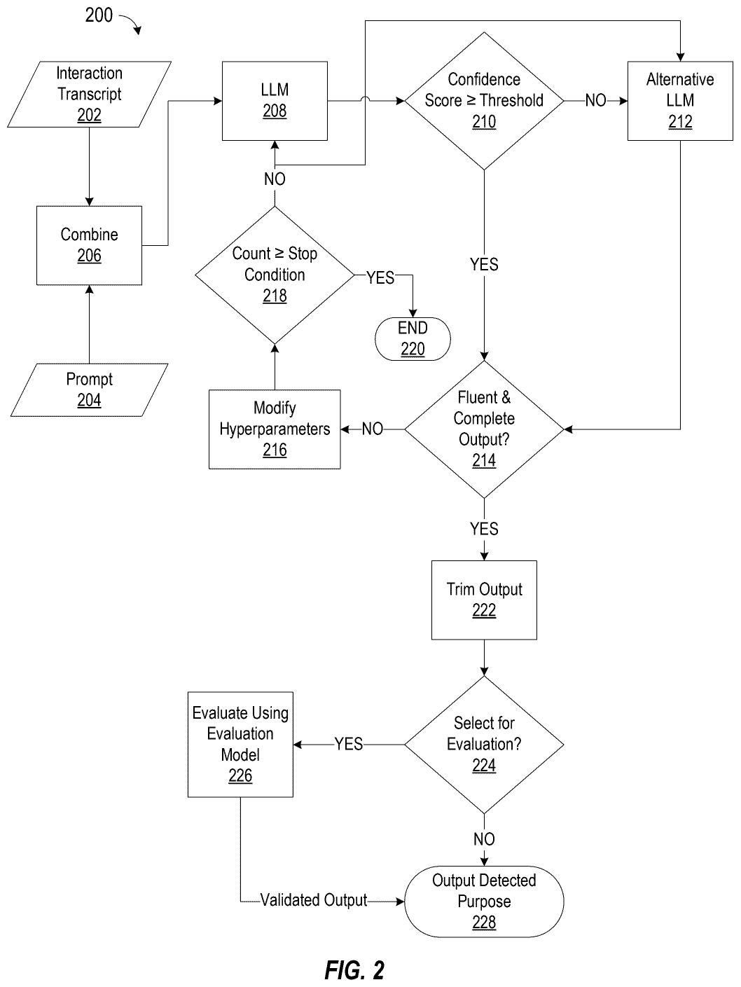

During the pre-processing stage 102, the corpus of historical interactions 104 are processed by an intent discovery sub-process, such as the intent discovery process 200 shown in FIG. 2, and described in greater detail below, to identify the intent of each interaction in the corpus of historical interactions 104. Related intents may be collected into an intent topic group created by component 106 of the resolution guidance system 100. For example, in the case of a product support (e.g., printers, mobile devices, home appliances, and the like) intents related to network or inter-device communication issues may be placed in a connectivity intent topic group, while intents related to software/firmware related issues may be placed in a software intent topic group. Intent topic groups may be created for other intent topics as well, such as subscription issues, billing, general product functions, and the like.

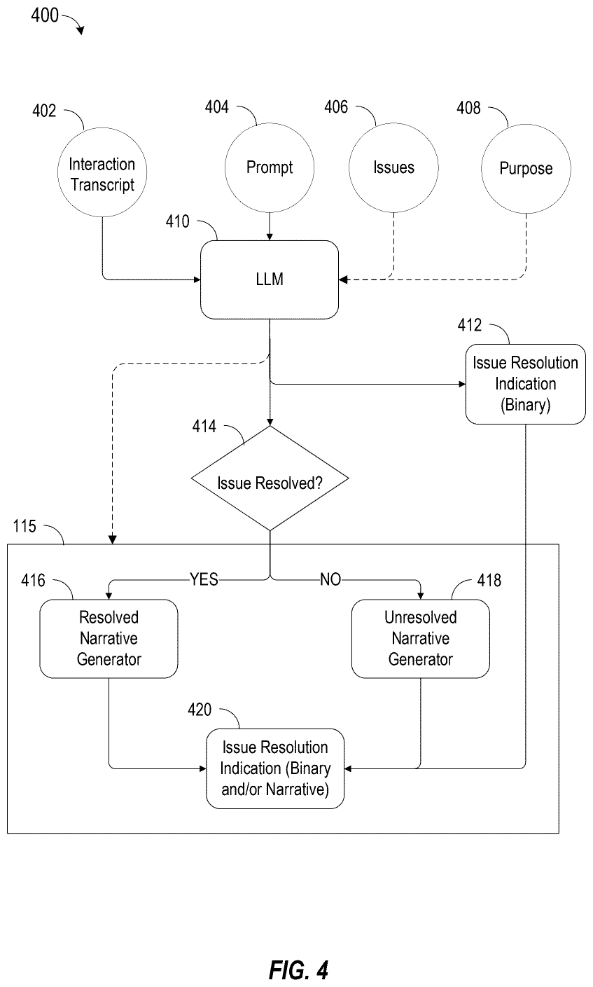

Additionally, component 108 of the resolution guidance system 100 creates resolution topic groups during the pre-processing stage 102. Creating the resolution topic groups includes executing an issue resolution identification sub-process, such as issue resolution indication process 400, shown in FIG. 4, and described in greater detail below. The issue resolution identification sub-process identifies a resolution of each of the interactions in the corpus of historical interactions 104. Related resolutions are grouped together in a resolution topic group.

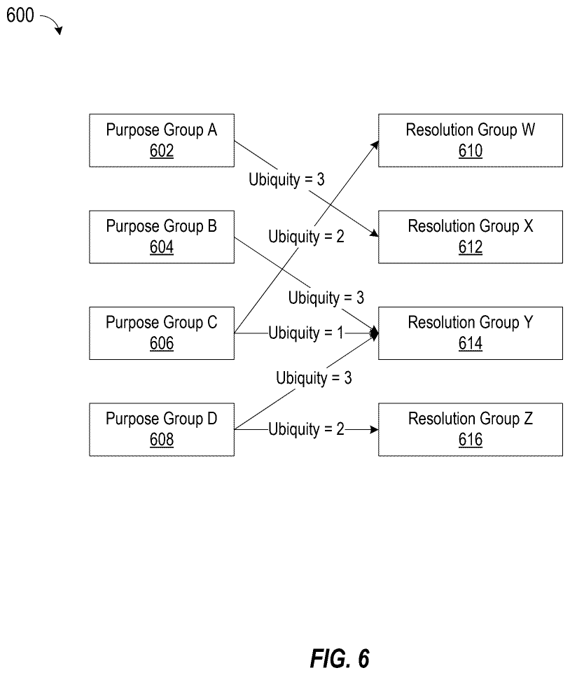

At component 110 the intents and the resolutions extracted from the corpus of historical interactions 104 by components 106 and 108 are paired and assigned weightings representing a ubiquity of resolutions from a particular resolution topic group appearing with intents in a particular intent topic group in the corpus of historical interactions 104. FIG. 6 illustrates a representation of intent-resolution pairs showing ubiquity weightings.

In FIG. 6, the ubiquity weightings are shown with values between 1 and 3. In alternative implementations, the ubiquity weightings may have values between 0 and 1, such as 0.1, 0.2, 0.3, 0.4, 0.5, 0.6, 0.7, 0.8, and 0.9. For example, intent group A 602 is paired with resolution group X 612 with a ubiquity weighting of 3. Certain aspects of the present disclosure provide for multiple intent groups being paired to one resolution group, as shown in FIG. 6, where intent group B 604, intent group C 606 and intent group D 608 are paired with resolution group Y 614. Each of the intent groups 604, 606, and 608, are given different ubiquity weights based on the prevalence of the resolution group being associated with the each intent group.

Additionally, certain aspects may provide for a single intent group, intent group C 606, for example, may be paired with more than one resolution group, such as resolution group W 610 and resolution group Y 614. Another example is provided by intent group D 608 paired with resolution group Y 614 and resolution group Z 616. As shown, each pairing between intent group C and resolution groups W, Y 610 and 614, respectively, has a different ubiquity weighting. However, in some implementation of aspects of the present disclosure, the ubiquity weightings between an intent group and each of the multiple paired resolution groups may have the same value.

Returning to FIG. 1, component 112 of the resolution guidance system 100 classifies the intent-resolution pairs as vectors stored in a vector datastore. A semantic embedding model (e.g., sbert) may be used to embed the intent-resolution pairs as numerical vectors. The vectors may be one dimensional, where the one dimension refers to the ubiquity of the resolution group. Alternatively, the vector may be multi-dimensional, where each dimension represents a different property or attribute of the intent-resolution pair. Once the intent-resolution pairs are stored at component 112, the pre-processing stage 102 is completed.

With the pre-processing stage 102 completed, the resolution guidance system 100 is ready for operation by executing the runtime stage 103. The runtime stage 103 includes component 114, which is configured to receive user utterances from a user interface. The user utterances may be received as text messages input in a chat module embedded in a corporate website. Alternatively, the user utterances may be received in the form of transcribed audio recorded from a telephone helpline. The audio transcription may be performed by a speech-to-text AI model, such as a natural language understanding (NLU) model, or a large language model (LLM). Non-machine learning speech-to-text techniques may be used to generate audio transcripts as well.

Component 116 of the resolution guidance system 100 identifies a user intent from the received user utterance. The user intent may be identified using a technique such as the intent discovery process 200 shown in FIG. 2.

Component 118 of the resolution guidance system 100 maps the user utterance to an intent-resolution pair. The mapping may involve identifying intent-resolution pairs that are semantically similar to the user intent. A classifier model or a large language model configured to identify an intent group that is semantically similar to the user intent may be employed by component 118. For example, sbert may be used to map the user intent to a numerical vector. Alternatively, word2vec, GloVe, or other natural language processing (NLP) embedding methods for determining semantic similarity may be used, as well. The vector value of the user intent is compared to the vector values of the intent topic groups to identify intent topic groups similar to the user intent. For example, in certain implementations of the aspects of the present disclosure, the vector value of the user intent may be compared to topic group labels. Alternatively, in other implementations the vector value of the user intent may be compared to a group centroid (which may be an average of the embedding vectors of all members of the group).

Various methodologies may be applied by component 118 to identify semantically similar intents, for example, implementations of certain aspects of the present disclosure may apply a Cosine similarity function:

$$Similarity Score ( S ) = cos ( ∅ ) = \frac{AB}{‖ A ‖ ‖ B ‖} = \frac{{\sum }_{i = 1}^{n} {A}_{i} {B}_{i}}{\sqrt{{\sum }_{i = 1}^{n} {A}_{i}^{2}} \sqrt{{\sum }_{i = 1}^{n} {B}_{i}^{2}}} , \qquad ( Eq . l )$$

where Aᵢ and Bᵢ are the ith component of n-dimensional vectors A and B, which represent vector embeddings of intents, and θ represents the degree of similarity as an angle between vectors A and B to any one of the above-identified embedding models (sbert, word2vec, GloVe, etc.). Alternatively, Google Similarity Distance may be used in certain implementations of aspects of the disclosure. Google Similarity Distance, unlike sbert, word2vec, GloVe, does not require calculation of a cosine similarity.

The similarity score(S) is calculated using the cosine similarity between the encodings of two statements (e.g., the user intent (A) and a stored intent from the intent topic groups (B)). The encodings, generally represented as n-dimensional vectors, are generated using any appropriate NLP embedding model, such as sbert, stsb-roberta-large, paraphrase-mpnet-base, gtr-t5-large or other sentence transformer models.

A similarity threshold for the similarity scores may be used to determine which intent topic groups are semantically similar enough to be selected. For example, the similarity threshold may, in certain embodiments, be set at .75 (or 75%) similarity. Other similarity threshold values, such as .65, .70, .80, .85, .90, or the like, may be used as deemed appropriate. However, a similarity threshold value that is too permissive may allow intent topic groups that are not relevant to be selected, while an overly restrictive similarity threshold may exclude relevant intent topic groups, and thus, limit the subsequent resolution suggestions presented to the help center agent. Any intent topic groups above this similarity threshold is selected by component 118.

Once the user intent is mapped to one or more intent topic groups, component 120 of the resolution guidance system 100 selects one or more resolutions paired to the mapped intent topic group. The one or more paired resolutions may be selected based on ubiquity weightings between the resolution and corresponding intent. Moreover, a threshold ubiquity value may be used to limit the number and relevancy of the selected resolutions.

The selected one or more resolutions are presented to the help center agent by component 122. These one or more resolutions are presented as resolution suggestions from which the help center agent may choose a resolution to present to the customer. The resolution suggestions may be presented to the help center agent on a display of a local workstation, for example. Additionally, the help center agent may customize a selected resolution suggestion to personalize and/or enhance the selected resolution suggestion prior to presenting the selected resolution suggestion to the customer.

In implementations of certain aspects of the present disclosure, the resolution suggestions presented to the help center agent may be sorted and displayed according to the ubiquity weightings, such that the resolution suggestion that is most ubiquitous (i.e., most prevalent in the intent topic group) appears at the top of the list of resolution suggestions. Certain aspects of the present disclosure may provide for additional or alternative parameters (weightings) to be used for the selection of appropriate resolutions, as well. Thus, the resolution suggestions may be sorted according to other parameters in addition to, or instead of, ubiquity. An example parameter may be sentiment associated with the resolution. The sentiment may be obtained manually or automatically using, e.g., an LLM or keywords. Another example parameter may pertains to the help center agent that provided a certain resolution. If the help center agent is rated as successfully resolving customer issues more often, then resolutions originating from that help center agent may have a higher weighting than a help center agent that is less successful. Help center agent ratings may be determined based on customer comments, average length of interactions, or other metrics. The date a resolution was first provided, or last used by a help center agent, may also be used as a parameter. A date parameter allows for more recent resolutions to be preferentially weighted over older resolutions, thus reducing incidents in which outdated resolutions are presented to a customer. Older resolutions may no longer apply to current versions of the product due to firmware or software updates issued since the older resolution was first used.

In the context of the present disclosure, it is noted that a resolution is not intended to imply that the intent has been satisfied, rather the resolution presented to the customer may be considered as a best next action in a string of actions that may lead to a satisfactory conclusion to the customer's intent for contacting the help center. For example, during initial phases of an interaction, the resolutions suggested may involve asking the customer for additional information. The additional information may be used to refine the resolution suggestions until a final satisfactory resolution to the user intent is reached. Thus, resolutions may also be considered as next actions responsive to a user intent.

It is further noted that, under certain circumstances, the user intent for contacting the help center may not be resolved to the customer's satisfaction. For example, a product may be damaged in a manner that is not fixable by way of an interaction with the help center. However, for the intents of the present disclosure, arriving at such a conclusion may be considered as a successful resolution, since no further action can be taken by the help center agent, other than to for example, schedule an on-site repair technician, or issue a return merchandise authorization (RMA) tag.

In certain implementations of aspects of the present disclosure, component 124 may elicit feedback from the customer, the help center agent, or both, regarding the accuracy of the resolution suggestions in addressing the user intent. The feedback may be used by component 110 of the pre-processing stage 102 to adjust the weightings applied to the intent-resolution pairs.

### Example Intent Discovery Process

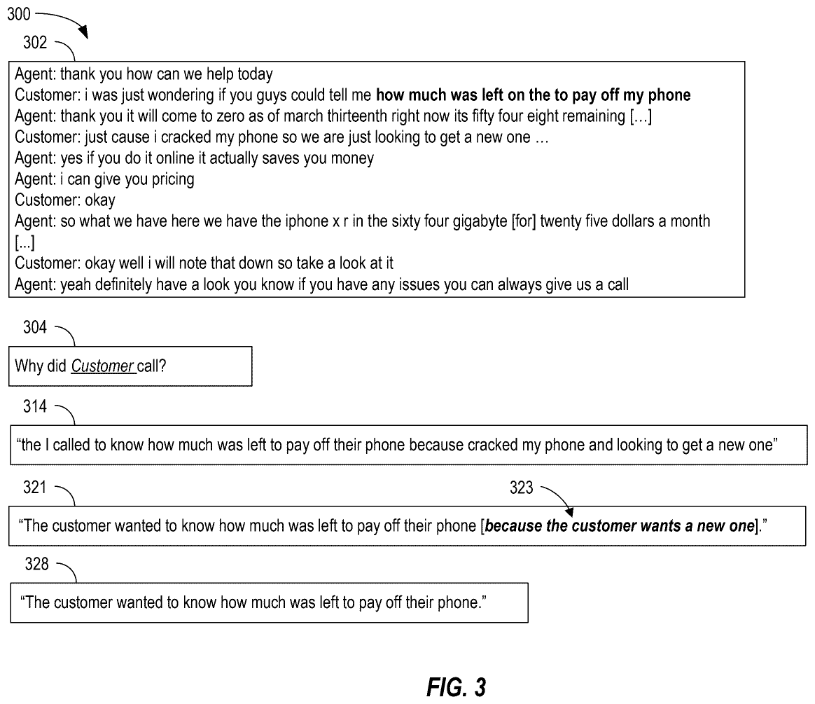

Turning to FIG. 2, an illustrative block diagram of an intent discovery process 200 for determining an intent of a conversational interaction in a narrative form is depicted. The intent discovery process 200 depicted in FIG. 2 will further be described with reference to the example content 300 input to, generated by, and output from the intent discovery process 200 that is depicted in FIG. 3. The intent discovery process 200 may be implemented by an apparatus having one or more memories with process-executable instructions, and one or more processors configured to execute the process-executable instructions. A feature of the intent discovery process 200 described herein is that the process does not depend on a specific domain or subject matter.

Interaction transcripts are generated, at step 202, from conversational interactions between two or more entities. The conversational interactions between two or more entities may be recorded in the form of audio, video, and/or text data. The data format of the recorded conversational interactions may be structured or unstructured. Therefore, to generate the interaction transcripts, one or more transcription tools, such as an audio-to-text or video-to-text conversion applications, may be used. For example, an example of an interaction transcript 302 is depicted in FIG. 3. Here, an audio conversation between an agent and a customer is transcribed into a text file. The interaction transcript can be stored in a data storage device that is accessible via a network by the apparatus or optionally stored in the one or more memories of the apparatus.

To initiate an LLM to perform an operation, generally, a prompt needs to be provided to the LLM. LLMs are a type of artificial intelligence model that have been trained through deep learning algorithms to recognize, generate, translate, and/or summarize vast quantities of written human language and textual data based on user input. The techniques described herein provide solutions that enable one or more LLMs to detect intents from conversational interactions and output a fluent, clear narrative that can readily be used by one or more other computer based applications or human representatives.

A prompt is a generated input to which the LLM is meant to respond. Prompts can include instructions, questions, examples, or any other type of input, depending on the intended use of the LLM. Prompts play a critical role in obtaining optimal results from the LLM, and how a prompt is written can affect the output that is generated. Accordingly, carefully designed prompts, referred to herein as an engineered prompts, are developed to generate desired outputs.

The prompt is engineered so as to elicit an abstractive description of the intent, such as “The customer called to cancel her account” as opposed to “Cancel account,” which is telegraphic speech and would not be an acceptable output because the output does not provide a narrative of the intent.

An example engineered prompt 304 is depicted in FIG. 3. At step 204, one or more processes for engineering prompts is conducted. For example, engineered prompt 304 is “Why did Customer call?” This prompt was refined from a previous version that was tried which recited “Why did the customer call?” because it was determined that the revised version provided better results from the LLM. This is merely an example to illustrate that subtle changes to the prompt can affect the output generated by an LLM. Other example prompts may include “What is the intent of the interaction?” and “Here follows the reason why the customer called.” In some embodiments, at step 204, a predetermined list of prompts is available such that the system can automatically select an engineered prompt 304 from the predetermined list of prompts to be utilized by the intent discovery process 200. The intent discovery process 200 may automatically iterate through one or more prompts defined in the predetermined list of prompts. Meanwhile, a user may override the automatic selection and implementation of an engineered prompt 304 from the predefined list of prompts with a manually selected and/or entered prompt.

The process of engineering prompts, for example, at step 204 may include iterating through multiple prompts with the same set of input data and comparing the outputs that are generated to determine the optimal engineered prompt for an operation. One or more optimal engineered prompts may be generated and manually selected or automatically selected and implemented with a first LLM as described with reference to step 206.

At step 206, the interaction transcript 302 and the engineered prompt 304 are combined for input into a first LLM. The combination of the interaction transcript 302 and the engineered prompt 304 form an input string in this example. In some aspects, the input to the first LLM may include an agent screen capture from the interaction, or voice and/or video clips of the interaction. In such aspects, the LLMs may be configured to receive inputs other than text input strings, and combine or pre-process the additional information, for example convert to a textual representation or the like so that it can be processed by the LLMs.

At step 208, the input string is processed by a machine-learning model, such as an LLM. Examples of LLMs include OpenAI™ ChatGPT™, NVIDIA® NeMO™ LLM, Meta™ LLaMa™, Google® BERT. The process described herein can implement one or more LLMs currently developed or that may be developed in the future.

The first LLM, based on the input string comprising the interaction transcript 302 and the engineered prompt 304, generates one or more outputs. In aspects of the present disclosure, the engineered prompt 304 is designed to instruct the first LLM to detect the intent expressed in the interaction transcript 302. The one or more outputs generated by the first LLM include, for example, a narrative of the detected intent and a confidence score. The confidence score is a value the LLM generates indicating a probability that the narrative of the detected intent output by the LLM is an intention in fact expressed in the interaction transcript 302. The confidence score may be a value between 0 and 1.

At step 210, the intent discovery process 200 implements a decision process based on the confidence score. More specifically, at step 210, a determination is made as to whether the confidence score is greater than or equal to threshold value. The threshold value can be preset and is optionally adjustable by the user or application implementing the intent discovery process 200.

If the determination is “No” at step 210, the process proceeds to step 212. At step 212, the input generated at step 206 is ingested by a second LLM, which is different than the first LLM. The first LLM and the second LLM may be different models or the same type of model that is trained differently or configured with different hyperparameters. In some instances, the first LLM or the second LLM may be a low complexity model in order to implement fast processes or implement fewer resources than a complex model. That is, avoiding the more complex model when it is not needed can be beneficial for resource efficiency such as reducing the computation power, memory resources, power, and/or latency.

Like the first LLM, the second LLM generates one or more outputs including, for example, a narrative of the detected intent and a confidence score. In some aspects, the confidence score generated by the second LLM is again checked to determine whether it is greater than or equal to the threshold at step 210, thus implementing iteration into the employment of different LLMs. However, in some aspects, the narrative of the detected intent by the second LLM is passed to step 214.

Returning briefly to step 210, if the determination is “Yes” at step 210, the process proceeds to step 214. At step 214, the narrative of the detected intent, either generated by the first LLM, the second LLM, or another LLM from steps 208-212 is subjected to a rules-based fluency and completeness check. For example, FIG. 3 depicts an example narrative 314 of the detected intent. The example narrative 314 is “the I called to know how much was left to pay off their phone because cracked my phone and looking to get a new one”. The rules-based fluency and completeness check at step 214 applies rules to determine whether the narrative 314 meets objectives such as grammar, spelling, punctuation, and other aspects of the English language or another language. In some embodiments, an artificial intelligence (AI) model that is configured to check grammar, spelling, punctuation, and other aspects of the English language or another language may be implemented at step 214. The AI model may be implement in conjunction with or independently from the rules-based fluency and completeness check process.

For example, as illustrated in the example narrative 314, there a number of issues that may be flagged by the rules-based fluency and completeness check at step 214. First, the example narrative 314 does not have proper capitalization at the beginning of the sentence. Second, the wrong expression of the subject, “I”, is used instead of, for example, “customer.” Third, the example narrative 314 is missing a subject between the words “because” and “cracked.” Fourth, the example narrative 314 does not have an ending punctuation mark. These and other issues may be identified by the rules-based fluency and completeness check at step 214. When the rules-based fluency and completeness check at step 214 determines that the narrative 314 of the detected intent does not conform to the predefined rules, for example, “No” at step 214, the process proceeds to step 216.

At step 216, modifications to hyperparameters may be made to the LLM (e.g., either the first LLM or the second LLM) that generated the current example narrative 314. For example, hyperparameter values of LLMs may include output length, beams number, and the like. Output length refers to the length of the output or a range of length the output of the LLM should be. In some instances, the LLM may output long incoherent narratives that fail to succinctly identify the intent. Beams number, such as beam size or beam width, is an aspect of a beam search strategy that considers multiple best options based on beamwidth using conditional probability.

If fluency or incompleteness issues are detected at step 214, such as an incomplete sentence, the LLM is iteratively run using different hyperparameters (such as minimal and maximal output length, beams number), until a fluent and complete output is generated. Using different hyperparameters or changing values of implemented hyperparameters can cause different outputs to be generated by the LLM. For example, if a longer output is desired, the output length generation parameters can be increased. By increasing the output length generation parameters, there is also a high (or increased) probability that the LLM will generate a complete sentence. The temperature and beam size hyperparameters can also be varied to get a more varied output, which may solve fluency issues. The hyperparameters can also be tuned to fit a user's style requirements, such as phrasing, length, or level of detail. Other fluency issues can be resolved by rule-based post processing, such as trimming and capitalization, for example, at step 222.

In some embodiments, at step 214, if fluency or incompleteness issues are detected by either the rules-based fluency and completeness check or by an AI model configured to check grammar, spelling, punctuation, and other aspects of the English language or another language, then the AI model may automatically correct any detected grammar, spelling, punctuation, and/or other issues with the narrative of the detected intent. The AI model may serve to supplement the LLM such that adjustments to the LLM may not be needed to continue with the intent discovery process 200 as the AI model could fix the language specific issues.

In some aspects, the process may include step 218, which is a counter that records and determines whether the process of modifying hyperparameters has iterated more than a specific number of times. If the count, for example, the number of iterations exceeds the stop condition, “Yes” at step 218, the process proceeds to step 220 and ends. If the count, for example, the number of iterations does not exceed the stop condition, “No” at step 218, the process proceeds to either step 208 or step 212 depending on which LLM generated the current example narrative 314 evaluated at step 214. The LLM that generated the current example narrative 314 may be tracked in the process by attaching a flag or other data indicator to the current example narrative 314.

Returning to step 214, either after the initial iteration or an additional iteration of the LLMs generating a narrative 314 of the of the detected intent, when the rules-based fluency and completeness check at step 214 determines that the narrative 314 of the detected intent from conforms to the predefined rules, for example, “Yes” at step 214, the process proceeds to step 222. For example, a conforming narrative 321 is depicted in FIG. 3.

In some instances, at step 222, another rules-based process is implemented. Here, the conforming narrative 321 is a fairly long narrative and includes some additional narration that is not specific to the intent. The conforming narrative 321 is “The customer wanted to know how much was left to pay off their phone because the customer wants a new one.” The rules-based process at step 222 may determine that the length exceeds a specified value and thereby implement a trimming operation that trims a portion 323 from the conforming narrative 321 as depicted in FIG. 3, for example. The trimming operation reduces the length of the conforming narrative to be equal to or less than a predefined length. While the trimming operation is optional, the trimming operation may provide the benefit of assuring that a narrative is concise and/or conforms with a text length requirement for a secondary process such as an intent categorization process or a reporting and storing process. In some aspects, the rules-based process at step 222 may also determine and implement other rules such as checking whether there are capitalization or punctuation issues and subsequently correcting them without requiring additional processing by the LLMs.

In some instances, the output from the rules-based process at step 222 is the final output detected intent 328 as depicted in FIG. 3, for example. However, in some instances, the process includes step 224 which includes a random selection operation for further evaluation of the final output detected intent 328. The selection process at step 224 may be a probabilistic selection whereby a fixed number of outputs per day or per quantity are selected for further evaluation. The selection process at step 224 can be based on quantity and frequency as two examples. In some instances, the selection process at step 224 is triggered by continuously low confidence scores being produced by the LLMs. For example, the system may track the confidence scores over time and if it is determined, that the confidence scores remain below a second predetermined threshold then selection of additional outputs for further evaluation may be triggered. Accordingly, the process implements a self-evaluation routine. This may be implemented even if the confidence scores are above the threshold in step 210, but are below the second predetermined threshold specified for step 224.

When an output is selected for further evaluation, for example a “Yes” determination at step 224, the process proceeds to step 226. At step 226, another LLM (and potentially a larger or more complex language model), referred to as an expert model, for example, T0++ or Google® Flan-T5-XL models, may be implemented to further evaluate the interaction transcript 302 and engineered prompt 304. The generated output from the expert model can be used as the new detected intent narrative or to correct the intent detected by the previous iteration of the LLMs in step 208 or 212. The output from step 226 is considered a validated output and replaces the trimmed conforming narrative 321 output from step 222.

In some aspects, if the expert model also flags low confidence, then the expert model may be used to generate a corrected intent. Alternatively, in all cases, if the original LLM flagged low confidence, then the larger language model generates a new, corrected intent. Alternatively, if the generated intent is flagged as low confidence by the expert model, no further attempts may be made and the output is tagged as “to be reviewed” and can be escalated for offline manual review. Results of automatic self-evaluation are logged for statistics and active learning. In the case of change in “low confidence” statistics, a review may be required to check for possible data drift. For example, drift refers to instances where the data that is processed during production strays away from the characteristics of the training data in such a way that it affects performance. When drift occurs, retraining, tuning, or updating the model may be required.

At step 228, the final output detected intent 328 is output by the process. The process may output the final output detected intent 328 to be stored in a memory location for later use or transmitted to a system such as a customer service center platform conducting conversational interactions with the customer. As described herein, the aforementioned process can be implemented in real-time or near-real-time with active customer interactions or as a post-process offline that ingests interaction transcripts and outputs detected intents in narrative form.

### Example Resolution Indication Process

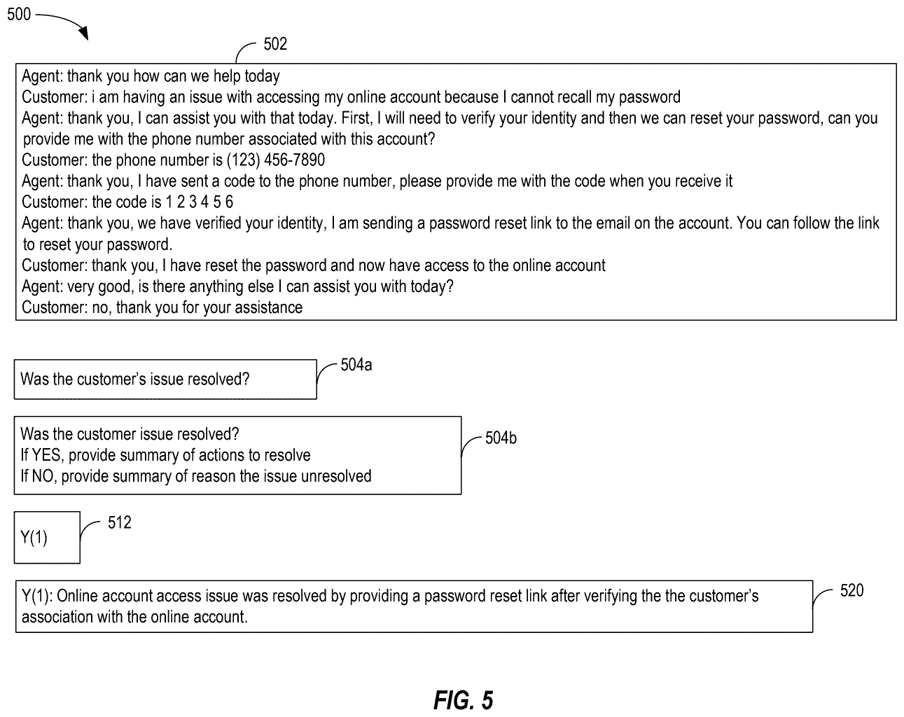

FIG. 4 depicts an illustrative block diagram of an issue resolution indication process 400. The issue resolution indication process 400 determines one or more issues expressed during a customer-agent interaction and provides an issue resolution indication that includes a binary indication regarding the resolution status and/or a narrative summarizing the actions implemented to resolve the issue or the reason an issue is unresolved. The issue resolution indication process 400 depicted in FIG. 4 will further be described with reference to the example content 500 depicted in FIG. 5.

The issue resolution indication process 400 may be implemented by an apparatus having one or more memories with process-executable instructions, and one or more processors configured to execute the process-executable instructions. A feature of the issue resolution indication process 400 described herein is that the process does not depend on a specific domain or subject matter. In practice, the issue resolution indication process 400 can be utilized by customers across a variety of domains. Additionally, the issue resolution indication process 400 aids in the reduction of maintenance and document management that would otherwise be required to support individual domain analysis of customer-agent interactions and resolution statuses thereof. That is, one or more large language models implemented in aspects of the issue resolution indication process 400 and the prompts may be generic and therefore capable to ingest and process a wide variety of subject matter.

Interaction transcripts 402 are generated from conversational interactions between two or more entities. The conversational interactions between two or more entities may be recorded in the form of audio, video, and/or text data. The data format of the recorded conversational interactions may be structured or unstructured. Therefore, to generate the interaction transcripts, one or more transcription tools, such as an audio-to-text or video-to-text conversion applications, may be used. The interaction transcript 502 depicted in FIG. 5, is an illustrative example of a customer contacting an agent at a contact center to help with accessing an online account that they are unable to access. In this example, the customer does not recall their password and the agent, through a second factor authentication process, provides the customer with a reset link so they can reset their password and access the online account. The issue of not being able to access an online account is resolved.

The interaction transcript 402 (e.g., the interaction transcript 502 depicted in FIG. 5) may represent an audio-to-text transcription of an audio conversation between an agent and a customer. The interaction transcript 402 can be stored in a data storage device that is accessible via a network by the apparatus or optionally stored in the one or more memories of the apparatus.

The issue resolution indication process 400 implements one or more LLMs to analyze the interaction transcript 402 and generate content for the issue resolution indication. Examples of LLMs include, but are not limited to, OpenAI's ChatGPT, NeMO™ LLM from NVIDIA®, LLaMa from Meta®, BERT from Google®, CLAUDE™ from Anthropic A.I., and FLAN-T5 from Google®. The process described herein can implement one or more LLMs currently developed or that may be developed in the future.

The issue resolution indication may include a report with only a binary indication regarding the resolution status of the one or more issues expressed in the interaction transcript 402. In some aspects, the issue resolution indication may include a binary indication and a narrative summarizing the actions implemented to resolve the issue or the reason an issue is unresolved.

The issue resolution indication process 400 may be one of several processes implemented in the analysis of an interaction transcript 402. For example, other processes may be configured to determine the intent of an interaction and generate a report of the intent that summarizes one or more intents expressed in the interaction transcript. For example, an intent discovery process 200 for obtaining the intent corresponding to the interaction transcript may include detecting the one or more intents, with a LLM, from an input comprising at least the interaction transcript and an intent prompt. Accordingly, the LLM may generate the intent narrative for the one or more intents expressed in the interaction transcript. It is noted that the LLM utilized for the intent discovery process 200 may be a different LLM than the one or more LLMs implemented for the issue resolution indication process 400 described herein.

The issue resolution indication process 400 implements a first LLM 410 configured to receive an interaction transcript 402 and a resolution prompt 404. The resolution prompt 404 may be automatically selected from a predefined list of resolution prompts or may be generated or received, by the system implementing the issue resolution indication process 400, from a tertiary sources, such as a user or a computing device orchestrating analysis of the interaction transcript. In some aspects, the first LLM 410 is configured to receive one or more issues 406 that have been extracted from the interaction transcript 402. For example, the one or more issues 406 may be extracted from another LLM (e.g., other than the first LLM 410) or another issue extraction process. In some aspects, the first LLM 410 may also be provided with the intent 408 (also referred to as an intent) corresponding to the interaction transcript 402. For example, an intent 408 may be a summary or an indication as to the reason for the interaction. The intent 408 may provide the first LLM 410 with guidance, for example, to extract issues that correspond to the intent 408. This may be advantageous to include for interactions that may include discussion of more than one issue, but which are not related to the overall intent 408 of the customer's interaction with the contact center. In aspects where the first LLM 410 is provided with the one or more issues 406 and/or the intent 408, the first LLM 410 may be a small language model (SLM) or a low complexity LLM designed for specific tasks corresponding to determining the issue resolution status and/or generation of narratives corresponding to the resolution status. A SLM or a low complexity LLM refer to types of language models that may be designed to have a smaller codebase than LLMs and/or smaller neural networks compared to LLMs. SLMs and low complexity LLMs may be more readily trained than LLMs and may be tailored to more narrow and specific applications, that potentially make them more practical for companies that require a language model that is trained on more limited datasets, which can be fine-tuned for a particular domain.

To initiate first LLM 410 to perform an operation, generally, a prompt is provided to the first LLM 410. As above, how a prompt is written can affect the output that is generated by the LLM model processing the prompt.

For the issue resolution indication process 400, the prompt is a resolution prompt 404. Two example resolution prompts are depicted in FIG. 5. A first resolution prompt 504a recites “Was the customer's issue resolved?” The first resolution prompt 504a, asks a Yes/No question (e.g., requests a binary indication) regarding the issue resolution status based on the interaction transcript 402 processed by the first LLM 410. A second resolution prompt 504b recites “Was the customer issue resolved? If YES, provide summary of actions to resolve; if NO, provide summary of reason the issue unresolved.” The second resolution prompt 504b asks a Yes-No question and requests a narrative response to a pair of conditional questions based on the Yes-No determination. These are merely two example resolutions prompts and others are possible. Depending on the architecture of the issue resolution indication process 400, the resolution prompt 404 (e.g., the first resolution prompt 504a or the second resolution prompt 504b) may be provided to one or more different LLMs. For example, the first resolution prompt 504a requesting a binary indication of the issue resolution status may be provided to a first LLM 410, while the second resolution prompt 504b or a similar resolution prompt that requests a narrative regarding the actions take or the reason the issue remains unresolved, may be fed into a different LLM to generate the requested narrative.

For example, the first LLM 410, shown in FIG. 4, may receive the interaction transcript 402 and a resolution prompt 404 such as the first resolution prompt 504a requesting a binary indication of the resolution status. The resolution prompt 404 may alternatively be a second resolution prompt 504b, for example, as depicted in FIG. 5. The first LLM 410 generates the binary indication, for example, in the form of a text value (e.g., “YES” or “NO”), a Boolean value (e.g., TRUE or FALSE), or a bit value (e.g., “0” or “1”) or expressed as a “Y” or “N”, “Yes” or “No”, or another form of binary data representation. A report 412 may be generated and output. For example, the report 412 may be a report 512 as depicted in FIG. 5. For example, a positive response, the report may include “Y,” “1,” or the like as depicted in the illustrative report 512. For a negative response, the report may include “N,” “0,” or the like. Report 512 depicted in FIG. 5 is merely an example. The report provides an issue resolution indication comprising the binary indication of the resolution status. At block 414, the issue resolution indication process 400 determines whether the issue expressed in the interaction transcript was resolved. If the issue is determined to be resolved, “YES” at block 414, then the issue resolution indication process 400 proceeds with generating a resolution narrative at block 416. If the issue is determined to be unresolved, “NO” at block 414, then the issue resolution indication process 400 proceed with generating a resolution narrative at block 418.

The issue resolution indication process 400 at blocks 416 and 418 may take one of a variety of actions to generate the respective narratives, for example a first narrative providing a summary of the actions taken to resolve the issue or a second narrative providing a summary of the reason why the issue remains unresolved. At block 416, the first LLM 410 may be prompted with a further prompt, such as “Provide a summary of actions to resolve the issue” whereby the first LLM 410 also receives the interaction transcript 402 and optionally the one or more issues 406. In another aspect, at block 416, a second LLM (e.g., different from the first LLM 410), may be prompted with a resolution prompt, such as “Provide a summary of actions to resolve the issue,” whereby the second LLM also receives the interaction transcript 402 and optionally the one or more issues 406. In further aspects, at block 416, a SLM or other generative AI model may be invoked to generate the first narrative. For example, an illustrative first narrative 520 is depicted in FIG. 5. This may be the issue resolution indication generated and output at block 420.

In some aspects, the first LLM 410 may be prompted to provide a resolution narrative directly instead of first generating and outputting an indication regarding whether the issue was resolved or not. For example, the first LLM 410 may be prompt to provide a resolution narrative, thus proceeding directly to block 415 where either one of the respective resolution narratives are generated at block 416 or block 418. In such aspects, a single LLM, for example, the first LLM 410 may be prompted to generate the resolution narrative which is output by block 415.

At block 418, the first LLM 410 may be prompted with a further prompt, such as “Provide a summary of the reason why the issue is unresolved” whereby the first LLM 410 also receives the interaction transcript 402 and optionally the one or more issues 406. In the instance where the first LLM 410 receives the one or more issues 406 as an input, the first LLM 410 may proceed with determining whether the one or more issues 406 were resolved. Conversely, in the instance the first LLM 410 does not receive the one or more issues 406 as an input, the first LLM 410 may first determine the one or more issues 406 present in the interaction transcript 402 and then determine whether the one or more issues 406 were resolved. As noted herein, if an intent 408 is input into the first LLM 410, the intent 408 may assist in directing the first LLM 410 with determining the one or more issues 406, since the intent 408 can provide the first LLM 410 with a targeted topic that the one or more issues 406 may be related to in the interaction transcript 402.

In another aspect, at block 418, a second LLM (e.g., different from the first LLM 410), may be invoked and prompted with a resolution prompt such as “Provide a summary of the reason why the issue is unresolved” whereby the second LLM also receives the interaction transcript 402 and optionally the one or more issues 406. In further aspects, at block 418, a SLM or other generative AI model may be invoked to generate the first narrative It is noted that the LLM invoked by blocks 416 and 418 may be the same LLM or a different LLM. Furthermore, block 416 and block 418 may invoke the same SLM or other generative AI model or different ones for generating the respective narratives.

The generated narrative, whether the first narrative from block 416 or the second narrative from block 418, may be compiled with the binary indication from the report 412 and output as issue resolution indication at block 420. In some aspects, the output of the issue resolution indication process 400, for example, the output generated by the narrative generator(s) at block 416 and/or block 418 may be a string data-type comprising the narrative summary or a tuple of two or more strings. The tuple may comprise a first string comprising the issue and a second string comprising the narrative summary. In an instance where the customer-agent interaction includes several issues, the output of the issue resolution indication process 400 may include a set of tuples, where each tuple comprises two or more strings, for example, as previously described.

An output from block 416 may be a tuple comprising a narrative of the issue and the first narrative. For example, the output may be a tuple comprising two strings “The customer wanted to know how much was left to pay off their phone” and “The agent told the Customer how much was left to pay off their phone.” Another example output from block 416 may include a tuple comprising two strings “The customer was looking to get a new phone.” And “The agent gave pricing information for new phones.” An output from block 418 may include, for example, the second narrative as a string reciting “Agent could not solve the technical issue and directed the Customer to a physical store.”

In some aspects, the issue resolution indication generated by the first LLM or any other LLM implemented by the issue resolution indication process 400 may generate a confidence score with the respective output generated by the model. The confidence score is a value the LLM generates indicating a probability that the binary indication and/or the respective narrative regarding the actions taken to resolve the issue or reason why the issue is unresolved is an accurate expression of the resolution status of the issue expressed in the interaction transcript 402. For example, the confidence score may be low if the LLM was required to make more inferences from the interaction transcript than identifying features expressing resolution of the issue, such as a confirmatory statement from the customer thanking the agent for assisting them with resetting their password. The confidence score may be, for example, a value between 0 and 1, or a percentage value between 0% and 100%.

If the confidence score does not meet a threshold, the issue resolution indication process 400 may process the interaction transcript with a larger or different language model. If the confidence score meets or exceeds the threshold, the obtained issue resolution indication can be affiliated with the interaction transcript and stored for use by another process. The threshold score may be 0.5 or 0.3 or 0.7, or any other value as appropriate. A higher threshold may cause more invocations of a larger LLM, and incurring the relevant costs. A smaller threshold, however, may mean that the help center agent may place less weight on the model's recommendations.

Other processes may include analytic applications analyzing a corpus of interaction transcripts and issues to determine analytics, such as common issues customer's contact the contact center about, whether those issues are able to be resolved, and the like. For example, the analytic applications analyzing a corpus of interaction transcripts and issues to determine analytics may be executed in an effort to improve contact center issue resolution assistance, product or service improvements, or other desired metric from a company offering a product or service or contact center administrator. In some aspects, if the confidence score does not meet the threshold on two or more models, a mechanism, such as majority voting, can be applied to determine which of the issue resolution indications is the best representation of the resolution in fact. In some aspects, no additional action may be taken when the issue resolution indication process 400 generates the issue resolution indication and the confidence score therefore.

The issue resolution indication process 400 may be implemented in a contact center to provide the agent with near-real-time indications or summaries of issues presented by the customer they are corresponding with. In some aspects, an indication, such as a checkmark or color indication associated with each of the one or more issues, may be presented to the agent on a dashboard (e.g., within a graphical user interface) for an active interaction so that the agent can track whether each issue the customer has called about has been resolved and/or whether further follow-up is needed to help resolve the issue. For example, the further follow-up, may be an indication that an issue cannot be resolved because the identity of the customer could not be verified. Accordingly, the agent, upon completion of the call, may provide the customer with next steps, such as have the account holder contact us so we may assist you with resolving the issue.

The issue resolution indication process 400 may output the issue resolution indication to be stored in a memory location for later use or transmitted to a downstream system, such as a customer service center platform conducting conversational interactions with the customer. As described herein, the aforementioned process can be implemented in near-real-time with active customer interactions or as a post-process offline that ingests interaction transcripts and outputs issue resolution indications in narrative form, which provides more accurate reporting, and an evidence-based, consistent method for determining and providing the issue resolution indication.

As used herein, the term “near real-time” refers to events occurring at a current time including a margin for processing time to provide generate a response to an input such that the response can be utilized during the occurrence of the event.

### Example GenAI-Based Resolution Guidance System

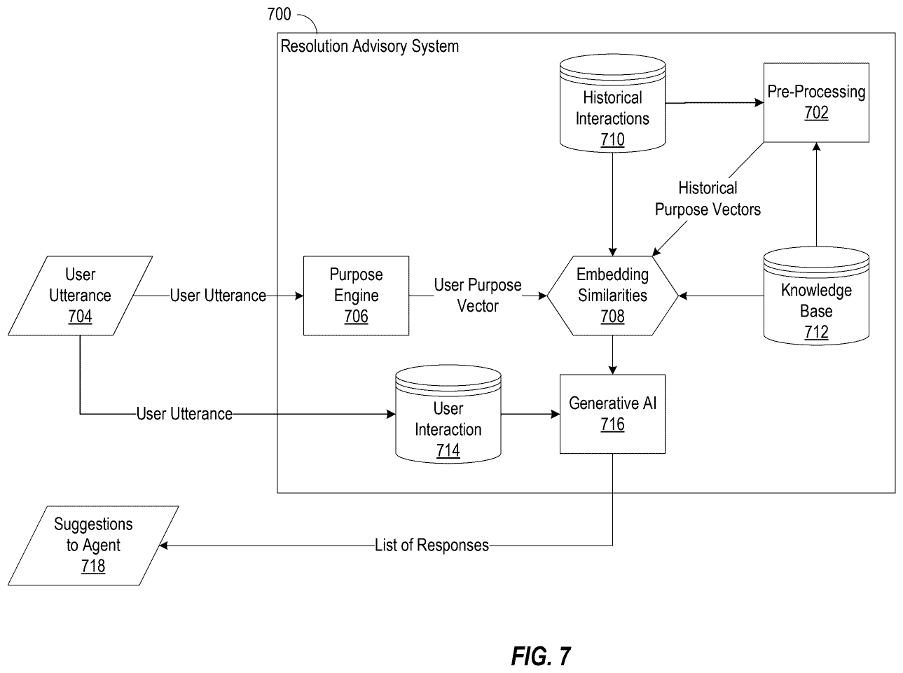

FIG. 7 discloses an example of another resolution guidance system 700 in accordance with aspects of the present disclosure. The resolution guidance system 700 differs from the resolution guidance system 100 shown in FIG. 1 by leverages a resolution guidance system 700 including a generative artificial intelligence (GenAI) model, such as an LLM, that has been trained using the intent-response pairs described above. However, the LLM in the resolution guidance system 700 uses the intent topic groups to identify similar historical interactions and relevant documentation. An utterance, related historical interactions and relevant documentation are provided to the LLM as a prompt, along with instructions to the LLM to identify best next actions (e.g., responses) for addressing the utterance based on the relevant documentation and related historical interactions.

For example, a simple prompt may be: “given the historical interactions: <A>, <B>, <C>, and following facts: <D>, and the current beginning of a customer-agent interaction <E>, what is the best action for the agent to follow?” In the example prompt, <A>, <B> and <C>represent the set of related historical interactions. However, usage of <A>, <B> and <C> are not intended as limiting the prompt to only three historical interactions, rather aspects of the present disclosure allow for any number of related historical interactions to be included in the prompt. The related historical interactions may be referenced in the prompt by an address or identifier of the related historical interactions. <D> represents documentation relevant for responding to the utterance. As with the related historical interactions, the documentation referenced in the prompt is not limited to a single document, but may be any number of documents deemed relevant to the current user utterance. <E> represents at least the current utterance, however, the prompt may include prior utterances of the customer as well. The current utterance and prior utterances may be referred to as a user interaction. Including prior utterances along with the current utterance may allow the LLM to generate a more complete set of resolutions. In addition the user interaction may include previous responses provided to the customer by the help center agent as well.

Initially, the resolution guidance system 700 executes a pre-processing stage 702, in which historical intents are extracted from each interaction in the historical interactions 710 using, for example, the technique shown in FIG. 2 and described above. Additionally, the pre-processing stage 702 transforms the historical intents into numerical vectors (historical intent vectors) using an embedding language model (ELM). Similarly, the pre-processing stage 702 transforms documentation of a knowledge base 712 into numerical vectors (documentation vectors), as well, using the ELM. The historical intent vectors and the documentation vectors may be stored in a vector database (vector store).

A user utterance 704, in the form of, for example, text received through a chat application, or a transcript of an audio conversation between a customer and a help center agent is provided to the resolution guidance system 700.

The user utterance 704 is provided to an intent engine 706. Additionally, in implementations of certain aspects of the present disclosure, the user utterance 704 may be stored along with previous user utterances of the present conversation, and collectively referred to as a user interaction 714. Certain aspects of the present disclosure, may further provide for the user interaction 714 to include previous responses provided to the customer by the help center agent as well. The intent engine 706 may be implemented by a NLU model, an LLM, or other appropriate machine learning models. The intent engine 706 identifies an intent (i.e., user intent) of the user utterance 704, using, for example, the technique shown in FIG. 2 and described above. Moreover, the user intent may be transformed into a numerical vector (user intent vector) having one or more dimensions representing parameters of the user intent using an ELM provided by the intent engine 706. The one or more dimensions may represent various linguistic and semantic properties, such as syntactic features, semantic features, sentiment, and the like. Moreover, the property of each dimension may be learned by the embedded AI model during training and fine-tuning. The intent engine 706 may be used as part of the pre-processing stage 702. Alternatively, the intent engine 706 and the AI models used in the pre-processing stage 702 may be different model instances.

The resolution guidance system 700 compares the user intent vector against the historical intent vectors to map the user intent vector to one or more semantically similar historical intent vectors, as embedding similarities identified by component 708. The semantic similarities between the user intent vector and each of the historical intent vectors are determined using, for example, the cosine similarity function (Eq. 1) described above. Other similarity functions may be used as well. Based on the embedding similarities identified by component 708, the resolution guidance system 700 retrieves related historical interactions and relevant documentation from the knowledge base 712.

The related historical interactions and relevant documentation, along with the user interaction 714 (including at least the latest user utterance 704), are provided as a prompt to a GenAI model 716, such as an LLM, or similar model. The GenAI model 716 prompted to provide a best next action, or resolution, in response to the user interaction 714, and limited by the historical interactions and documentation identified in the prompt. The output of the GenAI model 716 is provided to the help center agent as a list of one or more suggested resolutions provided at component 718. The suggested resolutions provided at component 718 may be sorted and displayed in accordance to a prevalence, or ubiquity, score assigned to each resolution by the GenAI model 716 as instructed by the prompt. Other attributes may be used as sorting criteria in addition to, or in place of the ubiquity score. The suggested resolutions provided at component 718 may be presented to the help center agent on a display of a local workstation, for example. Additionally, the help center agent may select and customize a suggested resolutions provided at component 718 to personalize and/or enhance the selected suggested resolutions provided at component 718 prior to presenting the selected suggested resolutions provided at component 718 to the customer.

In accordance with aspects of the present disclosure, the resolution guidance system 100 and resolution guidance system 700 may be used to provide suggestions to a help center agent in real time during an interaction with a customer as described above. Additionally, the resolution guidance system 100 and resolution guidance system 700 may be leveraged as a training tool, in which a recent user interaction may be processed as user utterances in order to identify resolution suggestions. These resolution suggestions may be compared against the actual actions taken by the help center agent during the interaction with the customer. In this way, the help center agent can evaluate their performance and adjust accordingly for future interactions.

### Example Data Flow

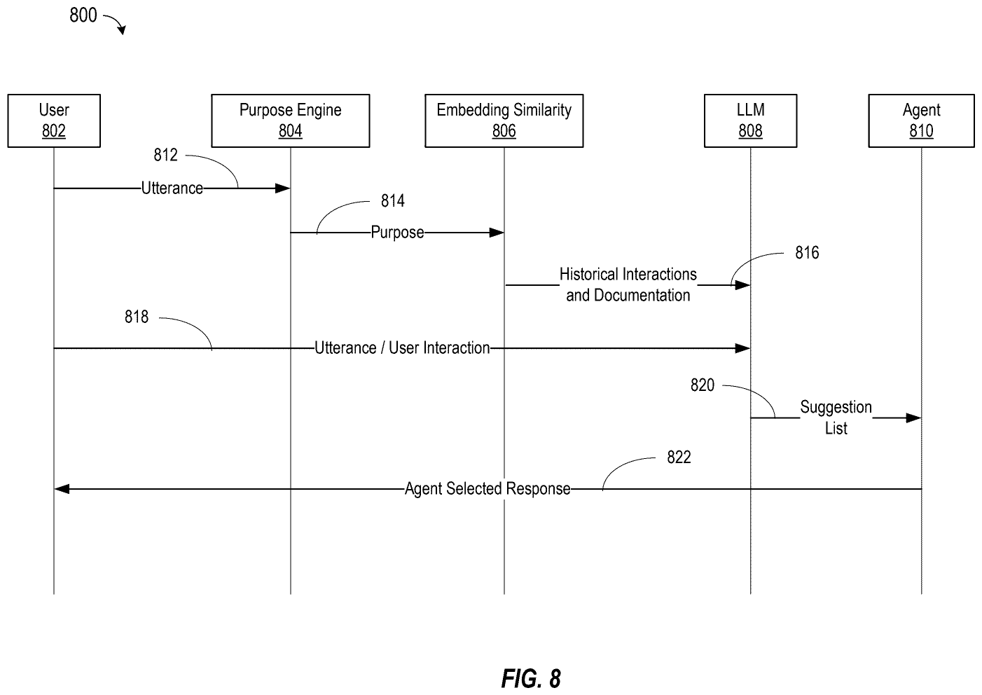

FIG. 8 shows an example data flow during operation of aspects of the present disclosure, as in, for example, the resolution guidance system 700 shown in FIG. 7.

As shown in FIG. 8, a user 802 provides an utterance 812 to an intent engine 804. The intent engine 804 extracts an intent 814 of the utterance 812, as described above with respect to FIG. 2, for example, and transforms the intent 814 to a numerical vector. The vector of the intent 814 is provided to an embedded similarity module 806, which compares the intent vector against historical intent vectors to identify related historical interactions and relevant documentation 816. The related historical interactions and relevant documentation 816 are provided to an LLM 808 along with a prompt containing the current utterance and previous utterances as a user interaction 818. The LLM 808 generates a suggestion list 820 that includes one or more resolution suggestions. The suggestion list 820 is presented to a help center agent 810. The help center agent 810 selects an appropriate resolution from among the one or more resolution suggestions and provides, to the user 802, the selected resolution as a response 822 to the user interaction 818.

### Example Methods

As described above, current methods for responding to a customer request for assistance through a help center, generally involves interactions between the customer and a help center agent, either human or automated. In the case of a human, the help center agent must undergo thorough training, often under the guidance of a supervisor or experienced help center agent. Thus the training can result in increased cost and a decrease in efficiency, since neither the trainee agent nor the experienced agent or supervisor is able to focus on responding to customer calls. Instead, both the trainee agent and the experienced agent or supervisor must dedicate significant time and effort to training. Even automated systems require significant setup and update time to keep the system current with new products and services. Moreover, once trained a help center agent must still periodically undergo refresher training in order to maintain proficiency with the latest products and services.

Often help center agents are provided a scripted guide to assist in responding to a customer. However the scripted guides may be time-consuming during an interaction with a customer, thus leading to delays in responding to customer utterances. Furthermore, it may be difficult for a help center agent to be familiarized with the latest product or service manuals. This can lead to the help center agent providing outdated information to the customer.

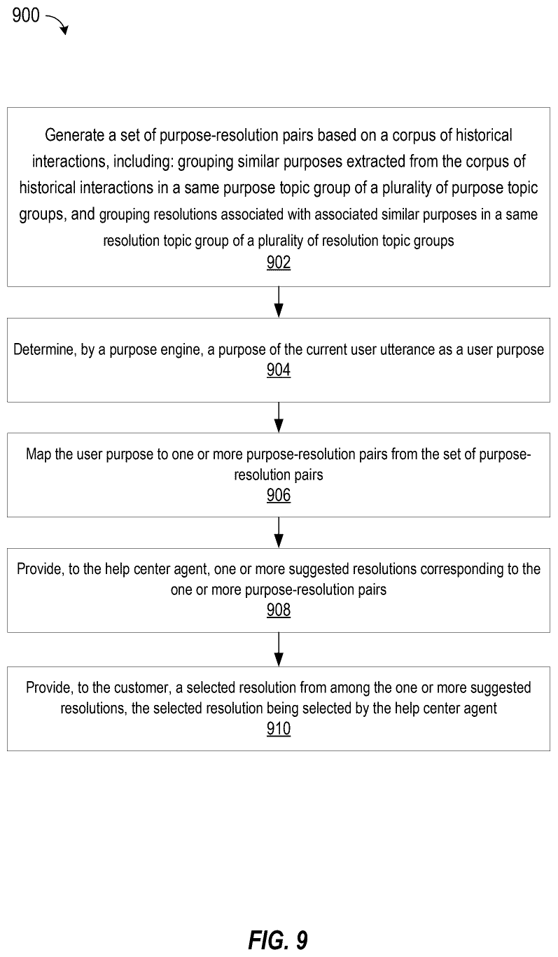

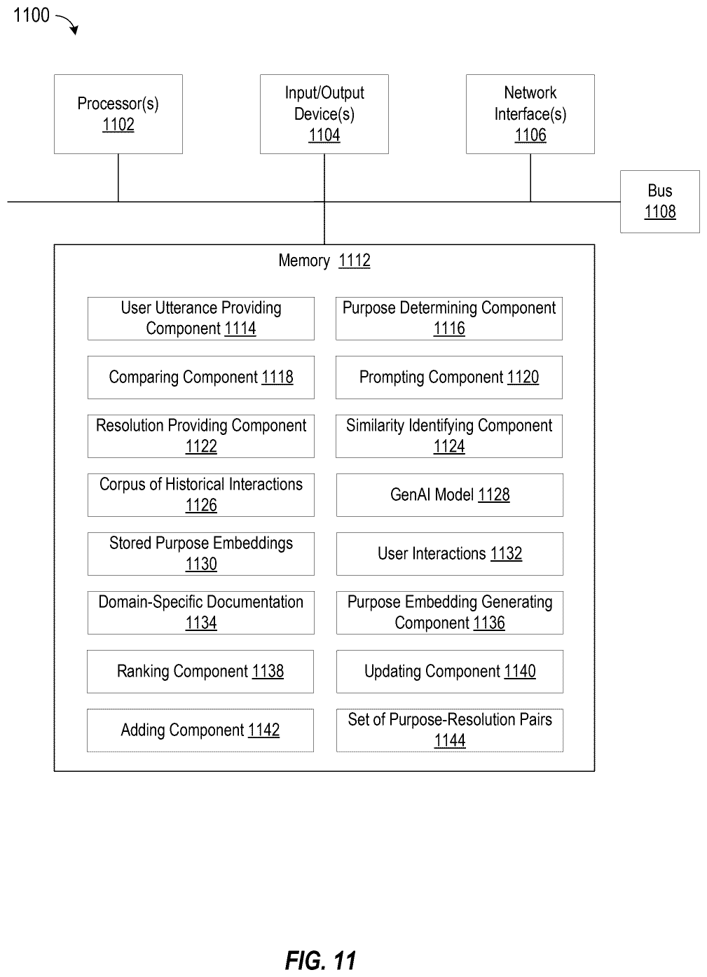

FIG. 9 provides a method 900 for providing resolution guidance to a help center agent. The method 900 may be performed by a system, such as resolution guidance system 100 shown in FIG. 1, or processing system 1100 shown in FIG. 11.

At block 902, method 900 generates a set of intent-resolution pairs based on a corpus of historical interactions. Method 900 may transform each intent extracted from the historical interactions into an intent embedding, namely, a vector representation of the respective intent. Additionally, method 900 may transform each resolution extracted from the historical interactions into a resolution embedding, namely, a vector representation of the respective resolution. Block 902 may employ the techniques described above with respect to FIG. 2 and FIG. 3.

At block 902, the method may, additionally, group similar intents extracted from the corpus of historical interactions in a same intent topic group of a plurality of intent topic groups. At block 902, the method may, also, group resolutions corresponding to associated similar intents in a same resolution topic group of a plurality of resolution topic groups.

In some implementations of aspects of the present disclosure, each intent-resolution pair includes a weighting representing a ubiquity between an intent and a resolution of each intent-resolution pair representing a prevalence of the resolution being associated with the intent in a corpus of historical interactions. In some implementations, method 900 may adjust weightings of each intent-resolution pair based on an outcome of the selected resolution to the current user utterance.

At block 904, method 900 determines, by an intent engine, such as component 116 in FIG. 1, an intent of the current user utterance as a user intent. The intent engine may employ artificial intelligence, such as an LLM, as described above with respect to FIG. 2.

At block 906, method 900 maps the user intent to one or more intent-resolution pairs from the set of intent-resolution pairs. Block 906 may be implemented by component 118 in FIG. 1. At block 906, the method 900 may also, match the user intent with a similar intent group, and choose at least one resolution paired to the similar intent group to be provided to the help center agent as the one or more suggested resolutions. Matching the user intent with the similar intent group may include feeding the user intent to one of a classifier model or a large language model configured to identify an intent group that is semantically similar to the user intent.

At block 908, method 900 provides, to the help center agent, one or more suggested resolutions corresponding to the one or more intent-resolution pairs.

At block 910, method 900 provides, to the customer, a selected resolution from among the one or more suggested resolutions, the selected resolution being selected by the help center agent. Block 908 and block 910 may be implemented by component 122 in FIG. 1.

In some implementations, an updating process is provided, in which method 900 may update the corpus of historical interactions with recent interactions at set intervals. The method 900 additionally generates recent intent embeddings and recent resolution embeddings from the recent interactions. The updating is completed with method 900 adding the recent intent embeddings and the recent resolution embeddings to intent topic groups and resolution topic groups, respectively.

The method 900 described above provides a solution to the above-identified deficiencies in the current help center customer experience by leveraging historical interactions and classifier models to identify the most prevalent resolutions, e.g., agent responses and actions, and providing one or more as suggested resolutions to the help center agent. The help center agent, provided with the suggested resolutions, preferably arranged according to a ubiquity score, may be able to better respond to the customer utterance in a manner that optimally moves the interaction to a satisfactory conclusion. Additionally, the method 900 may periodically update the historical interactions, thus maintaining up-to-date resolutions from which to provide suggestions to the help center agent. Consequently, the help center agent can avoid or reduce the chance of providing outdated information to the customer.

Note that FIG. 9 is just one example of a method consistent with aspects described herein, and other methods having additional, alternative, or fewer steps are possible consistent with this disclosure.

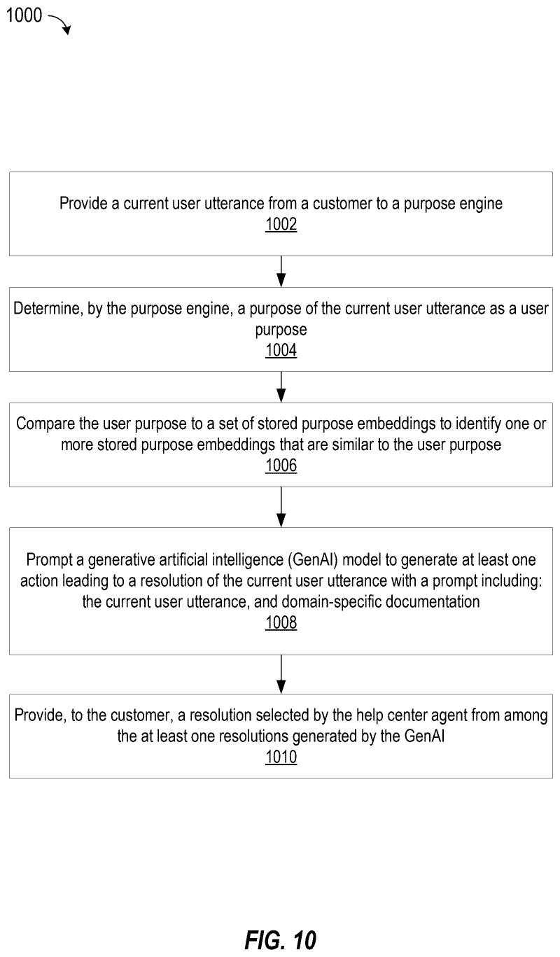

FIG. 10 provides a method 1000 for providing resolution guidance to a help center agent. The method 1000 may be performed by a system, such as resolution guidance system 700 shown in FIG. 7, or processing system 1100 shown in FIG. 11.

At block 1002, the method 1000 provides a current user utterance (e.g., 704 of FIG. 7) from a customer to an intent engine (e.g., intent engine 706 of FIG. 7).

At block 1004, the method 1000 determines, by the intent engine, an intent of the current user utterance as a user intent. The intent engine may employ artificial intelligence, such as an LLM, as described above with respect to FIG. 2.

At block 1006, the method 1000 compares the user intent to a set of stored intent embeddings to identify one or more stored intent embeddings that are similar to the user intent. Block 1006 may be implemented by component 708 of FIG. 7. Moreover, at block 1006, the method 1000 may compare the user intent to a set of stored intent embeddings to identify one or more stored intent embeddings that are similar to the user intent.

In some implementations, at block 1006, the method 1000 may also generate a user intent embedding by converting the user intent into a numerical vector using an ELM. Moreover, the method 1000, at block 1006, may identify the one or more stored intent embeddings based on a similarity with the user intent embedding (e.g., user intent vector). The similarity between the user intent embedding and the one or more stored intent embeddings may be calculated using a cosine similarity function (Eq. 1) described above.

At block 1008, the method 1000 prompts a generative artificial intelligence model (e.g., GenAI model 716 of FIG. 7) to generate at least one action leading to a resolution of the current user utterance. The prompt may include: the current user utterance, and domain-specific documentation. The GenAI model, in some implementations, may be a pre-trained large language model fine-tuned using intent-resolution pairs extracted from the corpus of historical interactions.

In some implementations of aspects of the present disclosure, the prompt may also include: historical interactions related to the one or more stored intent embeddings selected from a corpus of historical interactions (e.g., 710 of FIG. 7). Additionally, the domain-specific documentation may be associated with the one or more stored intent embeddings. Further, the prompt may include prior user utterances related to the current user utterance, and prior help center agent responses to the customer, the help center agent responses including one or more resolutions provided to the customer in response to the prior user utterances. The current user utterance, the prior user utterances, and the prior help center agent responses constitute a user interaction by the customer.

At block 1010, the method 1000 provides, to the customer, a resolution selected by the help center agent from among the at least one resolutions generated by the GenAI. Block 1010 may be implemented by component 718 of FIG. 7.

In some implementations of aspects of the present disclosure the method 1000 may also rank the historical interactions related to the one or more stored intent embeddings based on one or more of: a quality estimation, duration, resolution status, customer sentiment, date (e.g., age) of each of the historical interactions, or compliance score. Additionally, the historical interactions related to the one or more stored intent embeddings may be arranged in the prompt in accordance with the ranking.

In some implementations of aspects of the present disclosure, the method 1000 may update the corpus of historical interactions with recent interactions at set intervals. The method 1000 may also generate recent intent embeddings from the recent interactions. Further, the method 1000 may add the recent intent embeddings to the set of stored intent embeddings.

The method 1000 described above provides a solution to the above-identified deficiencies in the current help center customer experience by leveraging historical interactions and GenAI to identify the most relevant documentation, e.g., articles, service manuals, technical manuals, and the like, and providing one or more as suggested resolutions based on the relevant documentation to the help center agent. The help center agent, provided with the suggested resolutions, preferably arranged according to a ubiquity score, may be able to respond to the customer utterance in a manner that moves the interaction to a satisfactory conclusion in the least amount of time. Additionally, the method 1000 may periodically update the historical interactions, thus maintaining up-to-date resolutions from which to provide suggestions to the help center agent. Consequently, the help center agent can avoid or reduce the chance of providing outdated information to the customer.

Note that FIG. 10 is just one example of a method consistent with aspects described herein, and other methods having additional, alternative, or fewer steps are possible consistent with this disclosure.

### Example Processing System

FIG. 11 depicts an example processing system 1100 configured to perform the methods described herein. The processing system 1100 may be configured to execute a resolution guidance method, such as method 900 shown in FIG. 9 or method 1000 shown in FIG. 10.

Processing system 1100 includes one or more processors 1102. Generally, processor(s) 1102 may be configured to execute computer-executable instructions (e.g., software code) to perform various functions, as described herein.

Processing system 1100 also includes input(s) and output(s) 1104, which generally provide means for providing data to and from processing system 1100, such as via connection to computing device peripherals, including user interface peripherals.

Processing system 1100 additionally includes a network interface(s) 1106, which generally provides data access to any sort of data network, including personal area networks (PANs), local area networks (LANs), wide area networks (WANs), the Internet, and the like.

Processing system 1100 further includes a memory 1112 configured to store various types of components and data.

Processing system 1100 furthermore includes a bus 1108, which may generally be configured for data and/or power exchange amongst the components. Bus 1108 may be representative of multiple buses, while only one is depicted for simplicity.

In this example, memory 1112 includes a user utterance providing component 1114, an intent determining component 1116, a comparing component 1118, a prompting component 1120, a resolution providing component 1122, a similarity identifying component 1124, a GenAI model 1128, an intent embedding generating component 1136, a ranking component 1138, an updating component 1140, and an adding component 1142. Additionally, memory 1112 includes data used by the various components during operation, such as a corpus of historical interactions 1126, stored intent embeddings 1130, user interactions 1132, domain-specific documentation 1134, and a set of intent-resolution pairs 1144.

The user utterance providing component 1114 is configured to perform block 1002 shown in FIG. 10, for example, such that the user utterance providing component 1114 may provide a current user utterance from a customer to the intent engine (e.g., 706 of FIG. 7). The intent engine may use artificial intelligence, such as an LLM (as described with respect to FIG. 2), to determine the intent of the current user utterance.

The intent determining component 1116 is configured to perform block 1004 shown in FIG. 10, for example, such that the intent determining component 1116 may determine, by the intent engine, an intent of the current user utterance as a user intent. The intent engine identifies an intent (i.e., user intent) of the user utterance, using, for example, the technique shown in FIG. 2 and described above. The intent engine 706 may also be used as part of a pre-processing stage (e.g., 702 of FIG. 7) for generating the stored intent embeddings 1130 from the corpus of historical interactions 1126.

The comparing component 1118 is configured to perform block 1006 shown in FIG. 10, for example, such that the comparing component 1118 may compare the user intent to a set of stored intent embeddings 1130 to identify one or more stored intent embeddings that are similar to the user intent.

The prompting component 1120 is configured to perform block 1008 shown in FIG. 10, for example, such that the prompting component may prompt a generative artificial intelligence (GenAI) model 1128 (e.g., 714 of FIG. 7) to generate at least one action leading to a resolution of the current user utterance with a prompt including: the current user utterance, historical interactions related to the one or more stored intent embeddings 1130 selected from the corpus of historical interactions 1126, and documentation associated with the one or more stored intent embeddings 1130 selected from the corpus of domain-specific documentation 1134.

The prompt may also include prior user utterances related to the current user utterance, and prior help center agent responses to the customer. The help center agent responses may include one or more resolutions provided to the customer in response to the prior user utterances. The current user utterance, the prior user utterances, and prior help center agent responses constitute a user interaction by the customer. Additionally, the prompt may include parameter settings and instructions for formatting the output of the GenAI model 1128. For example, prompt instructions may include a directive that each suggested resolution be limited to no more than 100 words, and the like.

The resolution providing component 1122 is configured to perform block 1010 shown in FIG. 10, for example, such that the resolution providing component may provide, to the customer, a resolution selected by the help center agent from among the at least one action.

The GenAI model 1128 may be a pre-trained large language model fine-tuned using intent-resolution pairs extracted from the corpus of historical interactions. The GenAI model 1128 receives the prompt generated by the prompting component 1120 and generates one or more resolution suggestions (or best next action suggestions) based on the relevant domain-specific documentation 1134 and instructions provided in the prompt.

The intent embedding generating component 1136 generates a user intent embedding by transforming the user intent into a numerical vector. The intent embedding generating component 1136 may incorporate an ELM to transform the user intent into the user intent embedding. The intent embedding generating component 1136 may be used to generate the stored intent embeddings 1130 from intents extracted from the corpus of historical interactions 1126, as well. In some implementations, the intent embedding generating component 1136 may be incorporated into the intent engine.

The similarity identifying component 1124 is configured to perform functions of block 1006 shown in FIG. 10, for example, such that the similarity identifying component 1124 may identify the one or more stored intent embeddings based on a similarity with the user intent embedding. The similarity identifying component 1124 may use a Cosine similarity function as described above with respect to Eq. 1.

The ranking component 1138 ranks the historical interactions related to the one or more stored intent embeddings based on one or more of: a quality estimation, duration, resolution status, customer sentiment, date (e.g., age) of each of the historical interactions, or compliance score. The historical interactions related to the one or more stored intent embeddings may be arranged in the prompt in accordance with the ranking provided by the ranking component 1138.

The processing system 1100 may include an updating function that causes the updating component 1140 and adding component 1142 to periodically execute. The updating component 1140 updates the corpus of historical interactions with recent interactions at set intervals. The updating component 1140 may instruct the intent embedding generating component to generate recent intent embeddings from the recent interactions. The adding component 1142 adds the recent intent embeddings to the set of stored intent embeddings 1130. The updating may occur at set time intervals, such as every 24 hours. Alternatively, the updating function may execute once a threshold number of user interactions have been completed.

The updating interval may be adjusted in practice to account for the processing bandwidth and time need to perform the updating. For example, the resolution guidance system 100 of FIG. 1 may require more processing bandwidth and time to perform an update than resolution guidance system 700 of FIG. 7, thus the update interval for resolution guidance system 100 may be set to once per week, while the update interval for resolution guidance system 700 may be performed daily.

### Example Clauses

Implementation examples are described in the following numbered clauses:

Clause 1: A method for providing resolution guidance to a help center agent, comprising: generating a set of intent-resolution pairs based on a corpus of historical interactions, including: grouping similar intents extracted from the corpus of historical interactions in a same intent topic group of a plurality of intent topic groups, and grouping resolutions associated with the similar intents in a same resolution topic group of a plurality of resolution topic groups; determining, by an intent engine, an intent of a current user utterance as a user intent; mapping the user intent to one or more intent-resolution pairs from the set of intent-resolution pairs; providing, to the help center agent, one or more suggested resolutions corresponding to the one or more intent-resolution pairs; and providing, to a customer, a selected resolution from among the one or more suggested resolutions, the selected resolution being selected by the help center agent.

Clause 2: The method of Clause 1, wherein generating the set of intent-resolution pairs includes: transforming each intent extracted from the historical interactions into an intent embedding comprising a vector representation of the respective intent; and transforming each resolution extracted from the historical interactions into a resolution embedding comprising a vector representation of the respective resolution.

Clause 3: The method of Clause 1 or Clause 2, further comprising: updating the corpus of historical interactions with recent interactions at set intervals; generating recent intent embeddings and recent resolution embeddings from the recent interactions; and adding the recent intent embeddings and the recent resolution embeddings to intent topic groups and resolution topic groups, respectively.

Clause 4: The method of any one of Clauses 1-3, wherein mapping the user intent includes: matching the user intent with a similar intent group; and choosing at least one resolution paired to the similar intent group to be provided to the help center agent as the one or more suggested resolutions.

Clause 5: The method of any one of Clauses 1-4, wherein matching the user intent with the similar intent group includes feeding the user intent to one of a classifier model or a large language model configured to identify an intent group that is semantically similar to the user intent.

Clause 6: The method of any one of Clauses 1-5, wherein each intent-resolution pair includes a weighting representing a ubiquity between an intent and a resolution of each intent-resolution pair representing a prevalence of the resolution being associated with the intent in a corpus of historical interactions.

Clause 7: The method of any one of Clauses 1-6, further comprising adjusting weightings of each intent-resolution pair based on an outcome of the selected resolution to the current user utterance.

Clause 8: A method for providing resolution guidance to a help center agent, comprising: providing a current user utterance from a customer to an intent engine; determining, by the intent engine, an intent of the current user utterance as a user intent; prompting a generative artificial intelligence (GenAI) model to generate at least one action leading to a resolution of the current user utterance with a prompt including: the current user utterance, and domain-specific documentation; and providing, to the customer, a resolution selected by the help center agent from among the at least one action.

Clause 9: The method of Clause 8, wherein the intent engine comprises an artificial intelligence model trained to determine the intent of the current user utterance.

Clause 10: The method of Clause 8 or Clause 9, further comprising: comparing the user intent to a set of stored intent embeddings to identify one or more stored intent embeddings that are similar to the user intent; and wherein: the prompt further comprises: historical interactions related to the one or more stored intent embeddings selected from a corpus of historical interactions, and the domain-specific documentation is associated with the one or more stored intent embeddings.

Clause 11: The method of any one of Clauses 8-10, wherein comparing the user intent to the set of stored intent embeddings includes: generating a user intent embedding by converting the user intent into a numerical vector; and identifying the one or more stored intent embeddings based on a similarity with the user intent embedding.

Clause 12: The method of any one of Clauses 8-11, further comprising: ranking the historical interactions related to the one or more stored intent embeddings based on one or more of: a quality estimation, duration, resolution status, customer sentiment, age, or compliance score, wherein the historical interactions related to the one or more stored intent embeddings are arranged in the prompt in accordance with the ranking.

Clause 13: The method of any one of Clauses 8-12, wherein the GenAI model is a pre-trained large language model fine-tuned using intent-resolution pairs extracted from the corpus of historical interactions.

Clause 14: The method of any one of Clauses 8-13, wherein: the prompt further comprises: prior user utterances related to the current user utterance; and prior help center agent responses to the customer, the help center agent responses including one or more resolutions provided to the customer in response to the prior user utterances, and the current user utterance, the prior user utterances, and the prior help center agent responses constitute a user interaction by the customer.

Clause 15: The method of any one of Clauses 8-14, further comprising: updating a corpus of historical interactions with recent interactions at set intervals; generating recent intent embeddings from the recent interactions; and adding the recent intent embeddings to the set of stored intent embeddings.

Clause 16: The method of any one of Clauses 8-15, wherein the artificial intelligence model comprises a large language model (LLM).

Clause 17: A processing system, comprising: a memory comprising computer-executable instructions; and a processor configured to execute the computer-executable instructions and cause the processing system to perform a method in accordance with any one of Clauses 1-16.

Clause 18: A processing system, comprising means for performing a method in accordance with any one of Clauses 1-16.

Clause 19: A non-transitory computer-readable medium storing program code for causing a processing system to perform the steps of any one of Clauses 1-16.

Clause 20: A computer program product embodied on a computer-readable storage medium comprising code for performing a method in accordance with any one of Clauses 1-16.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c). Reference to an element in the singular is not intended to mean only one unless specifically so stated, but rather “one or more.” For example, reference to an element (e.g., “a processor,” “a memory,” etc.), unless otherwise specifically stated, should be understood to refer to one or more elements (e.g., “one or more processors,” “one or more memories,” etc.). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more.

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for providing resolution guidance to a help center agent, comprising:
generating a set of intent-resolution pairs based on a corpus of historical interactions, including:
grouping similar intents extracted from the corpus of historical interactions in a same intent topic group of a plurality of intent topic groups, and
grouping resolutions associated with the similar intents in a same resolution topic group of a plurality of resolution topic groups;
determining, by an intent engine, an intent of a current user utterance as a user intent;
mapping the user intent to one or more intent-resolution pairs from the set of intent-resolution pairs;
providing, to the help center agent, one or more suggested resolutions corresponding to the one or more intent-resolution pairs; and
providing, to a customer, a selected resolution from among the one or more suggested resolutions, the selected resolution being selected by the help center agent.

2. The method of claim 1, wherein generating the set of intent-resolution pairs includes:
transforming each intent extracted from the historical interactions into an intent embedding comprising a vector representation of the respective intent; and
transforming each resolution extracted from the historical interactions into a resolution embedding comprising a vector representation of the respective resolution.

3. The method of claim 2, further comprising:
updating the corpus of historical interactions with recent interactions at set intervals;
generating recent intent embeddings and recent resolution embeddings from the recent interactions; and
adding the recent intent embeddings and the recent resolution embeddings to intent topic groups and resolution topic groups, respectively.

4. The method of claim 2, wherein mapping the user intent includes:
matching the user intent with a similar intent group; and
choosing at least one resolution paired to the similar intent group to be provided to the help center agent as the one or more suggested resolutions.

5. The method of claim 1, wherein each intent-resolution pair includes a weighting representing a ubiquity between an intent and a resolution of each intent-resolution pair representing a prevalence of the resolution being associated with the intent in a corpus of historical interactions.

6. The method of claim 5, further comprising adjusting weightings of each intent-resolution pair based on an outcome of the selected resolution to the current user utterance.

7. The method of claim 4, wherein matching the user intent with the similar intent group includes feeding the user intent to one of a classifier model or a large language model configured to identify an intent group that is semantically similar to the user intent.

8. A method for providing resolution guidance to a help center agent, comprising:
providing a current user utterance from a customer to an intent engine;
determining, by the intent engine, an intent of the current user utterance as a user intent;
prompting a generative artificial intelligence (GenAI) model to generate at least one action leading to a resolution of the current user utterance with a prompt including: the current user utterance, and domain-specific documentation; and
providing, to the customer, a resolution selected by the help center agent from among the at least one action.

9. The method of claim 8, further comprising:
comparing the user intent to a set of stored intent embeddings to identify one or more stored intent embeddings that are similar to the user intent; and wherein:
the prompt further comprises: historical interactions related to the one or more stored intent embeddings selected from a corpus of historical interactions, and
the domain-specific documentation is associated with the one or more stored intent embeddings.

10. The method of claim 9, wherein comparing the user intent to the set of stored intent embeddings includes:
generating a user intent embedding by converting the user intent into a numerical vector; and
identifying the one or more stored intent embeddings based on a similarity with the user intent embedding.

11. The method of claim 8, wherein: the prompt further comprises:
prior user utterances related to the current user utterance; and
prior help center agent responses to the customer, the help center agent responses including one or more resolutions provided to the customer in response to the prior user utterances, and
the current user utterance, the prior user utterances, and the prior help center agent responses constitute a user interaction by the customer.

12. The method of claim 9, further comprising:
ranking the historical interactions related to the one or more stored intent embeddings based on one or more of: a quality estimation, duration, resolution status, customer sentiment, age, or compliance score,
wherein the historical interactions related to the one or more stored intent embeddings are arranged in the prompt in accordance with the ranking.

13. The method of claim 8, further comprising:
updating a corpus of historical interactions with recent interactions at set intervals;
generating recent intent embeddings from the recent interactions; and
adding the recent intent embeddings to the set of stored intent embeddings.

14. The method of claim 9, wherein the GenAI model is a pre-trained large language model fine-tuned using intent-resolution pairs extracted from the corpus of historical interactions.

15. The method of claim 8, wherein the intent engine comprises a large language model (LLM) trained to determine the intent of the current user utterance.

16. A processing system for providing resolution guidance to a help center agent, comprising:
a historical interactions datastore having a corpus of historical interactions stored therein;
a knowledge datastore having a corpus of domain-specific documentation stored therein;
a memory comprising computer-executable instructions; and
one or more processors configured to execute the computer-executable instructions and cause the processing system to:
provide a current user utterance from a customer to an intent engine;
determine, by the intent engine, an intent of the current user utterance as a user intent;
compare the user intent to a set of stored intent embeddings to identify one or more stored intent embeddings that are similar to the user intent;
prompt a generative artificial intelligence (GenAI) model to generate at least one action leading to a resolution of the current user utterance with a prompt including: the current user utterance, historical interactions related to the one or more stored intent embeddings selected from the corpus of historical interactions, and documentation associated with the one or more stored intent embeddings selected from the corpus of domain-specific documentation; and
providing, to the customer, a resolution selected by the help center agent from among the at least one action.

17. The processing system of claim 16, wherein the one or more processors further cause the processing system to:
generate a user intent embedding by transforming the user intent into a numerical vector; and
identify the one or more stored intent embeddings based on a similarity with the user intent embedding.

18. The processing system of claim 16, wherein the prompt further includes:
prior user utterances related to the current user utterance; and
prior help center agent responses to the customer, the help center agent responses including one or more resolutions provided to the customer in response to the prior user utterances,
the current user utterance, the prior user utterances, and the prior help center agent responses constitute a user interaction by the customer.

19. The processing system of claim 16, wherein the one or more processors further cause the processing system to:
rank the historical interactions related to the one or more stored intent embeddings based on one or more of: a quality estimation, duration, resolution status, customer sentiment, age, or compliance score,
wherein the historical interactions related to the one or more stored intent embeddings are arranged in the prompt in accordance with the ranking.

20. The processing system of claim 16, wherein the one or more processors further cause the processing system to:
update the corpus of historical interactions with recent interactions at set intervals;
generate recent intent embeddings from the recent interactions; and
add the recent intent embeddings to the set of stored intent embeddings.

21. The processing system of claim 16, wherein the GenAI model is a pre-trained large language model fine-tuned using intent-resolution pairs extracted from the corpus of historical interactions.

22. The processing system of claim 16, wherein the intent engine comprises a large language model (LLM) trained to determine the intent of the current user utterance.
